(19) United States
(12) Patent Application Publication
(10) Pub. No.: US 2009/0071764 A1
(43) Pub. Date: Mar. 19, 2009

(54) BRAKE PAD FOR A BICYCLE

(75) Inventor: Paolo Fabris, Vicenza (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: CAMPAGNOLO S.R.L., Vicenza (IT)

(21) Appl. No.: 12/201,900

(22) Filed: Aug. 29, 2008

(30) Foreign Application Priority Data
Aug. 31, 2007 (IT) MI2007A001711

(51) Int. Cl. B62L 1/06; F16D 55/02; F16D 69/02; C08J 5/16

(52) U.S. Cl. 188/71.6; 188/24.12; 188/251 A; 523/155

(57) ABSTRACT

A brake pad (5) having a braking surface (9, 109), intended to be pressed during braking against a side (8) of a rim (3) of a wheel (2) of the bicycle (1), and thermal transmission means (11, 111) suitable for transferring heat away from the braking surface (9, 109) is disclosed. The heat that is generated at the braking surface (9, 109) during braking is taken away from the braking surface (9, 109) and transferred into other areas of the pad (5).

### FIELD OF INVENTION

The present invention concerns a brake pad for a bicycle.

### BACKGROUND

In the field of racing bicycles, there is now widespread use of components made from composite materials, such as materials made up of carbon fibres incorporated in a matrix of polymeric material. Among the components made with these materials, rims for bicycle wheels are highly esteemed because a combination of strength, elasticity and lightness can be obtained.

It has been found by the inventors of the present invention that rims made in this manner can hit a crisis point following intense braking. The brake pads rub on the rim and generate heat; it has been found that it is not unusual to reach temperatures of 200° C. The heat alters the mechanical characteristics of the polymeric matrix in which the carbon fibres are inserted, in particular decreasing its rigidity and mechanical resistance by as much as three orders of magnitude (i.e. by a factor of 1000), weakening the link between the matrix and the other components. A delamination of the rim can thus occur. In extreme cases, the rim can even break, or braking may not occur, having serious consequences with respect to the safety of the cyclist.

In the case of rims made from metallic material, the problem less extreme, but the heating of the rim can lead to a decreased braking efficiency.

### SUMMARY

The present invention relates to a brake pad for a brake of a bicycle that includes a braking surface intended to be pressed during braking against the side of the rim of a bicycle wheel. The brake pad includes thermal transmission means suitable for transferring heat away from the braking surface.

### BRIEF DESCRIPTION OF THE DRAWINGS

Further characteristics and advantages of the invention shall become clearer from the following description of some preferred embodiments thereof, made with reference to the attached drawings. In such drawings:

FIG. 1 shows a bicycle comprising a front wheel-brake assembly and a rear wheel-brake assembly;

FIG. 2 shows a perspective view of a brake of the bicycle of FIG. 1;

FIG. 3 shows a wheel-brake assembly of the bicycle of FIG. 1, represented in a rest configuration;

FIGS. 4 and 5 schematically show two embodiments of a pad for bicycle brakes according to the present invention.

### DETAILED DESCRIPTION OF THE PREFERRED EMBODIMENTS

### Introduction to the Embodiments

A brake pad according to a first aspect of the present invention includes a braking surface intended to be pressed during braking against a side of a rim of a wheel of the bicycle. The brake pad includes thermal transmission means suitable for transferring heat away from the braking surface.

It is clear that any material is capable of transmitting heat by conduction, and that in any system, heat is also transmitted by convection and by radiation; it is therefore clear that in any wheel-brake assembly the heat generated at the braking surface of the pads does not stay in this area, but transfers spontaneously from it towards other colder areas, over different times and in different ways according to the different circumstances. In the context of the present invention, the expression “thermal transmission means” is defined as an assembly of elements or materials provided in the brake pad specifically for its ability to transfer heat better than all of the other elements or materials present in the pad.

Due to the presence of such thermal transmission means, the heat generated at the braking surface during braking is taken away from this area and transferred into other areas of the pad. The amount of heat transferred to the rim is thus reduced and the risks due to overheating of the rim are limited.

In particular, it has been observed that, with conventional pads, the heat that is generated on the braking surface stays on the surface and is dispersed by contact with the surrounding air after braking has ended. In the brake pad according to the invention, the thermal transmission means also take heat away from the braking surface during braking, and as a result the risk of excessively heating the rim does not exist, even during prolonged braking.

Preferably, the pad comprises a heat exchange surface towards the outside of the pad, distinct from the braking surface, in which the thermal transmission means transmit heat from the braking surface to the heat exchange surface. This establishes a preferential pathway through which the heat produced by braking is transferred to outside the pad, resulting in less overheating of the pad, and improved ability to transfer heat away from the braking surface.

Preferably, the heat exchange surface is suitable for contacting a pad-carrying support, or alternatively for contacting air. In a first embodiment, the heat exchange surface is preferably flat and regular, in order to promote the transmission of heat by contact, and the pad-carrying support is be made from a material with a high thermal conductivity. In a second embodiment, the heat exchange surface is as wide as possible, and preferably finned, in order to maximize the area of contact with air. Advantageously, the pad is also cooled during braking without the need to alter its conventional size, since surfaces that are already present on the pad can be exploited as heat exchange surfaces.

According to one preferred embodiment, the pad comprises a matrix of high-friction material, and the thermal transmission means comprise filaments of material having higher thermal conductivity than the material of the matrix, incorporated in the matrix. Preferably, the filaments are close to the braking surface but are not actually on it, so as not to interfere with the conditions of contact between the pad and the side of the rim, and consequently with braking performance. Preferably, the filaments are made from material having thermal conductivity of over 50 W/m° K, and more preferably over 150 W/m° K. Preferably, the material is metallic, and more preferably zinc, iron, steel, aluminium, copper or silver.

According to another preferred embodiment, the pad comprises a matrix of high-friction material and the thermal transmission means comprise granules of material having higher thermal conductivity than the material of the matrix, incorporated in the matrix. Preferably, the granules are distributed throughout the matrix, including the braking surface, since the granulated structure does not interfere unacceptably with the conditions of contact between the brake pad and the side of the rim. Due to the presence of the granules already on the braking surface, the efficiency of heat dispersal is maximized. Moreover, the construction of the pad is particularly simple and cost-effective, with it being sufficient to add the granules to the mixture with which the matrix is formed. Preferably, the granules are of a material having thermal conductivity of over 50 W/m° K, and more preferably over 150 W/m° K.

Preferably, the granules have an average size of less than 500 μm, and more preferably less than 200 μm. With this size, a satisfactory dispersal in the rubber is obtained, the rim is prevented from being abraded, and at the same time the aggregation between the rubber particles is not hindered.

Preferably, the matrix is made from rubber and the granules are made from graphite, preferably expanded natural graphite. By using such granules, it has been found that there is a better aggregation between the rubber molecules compared to other types of granules and less abrasion to the rim. In this case, the granules have an average size of between 10 μm and 100 μm. Compared to smaller-sized granules, these granules are less volatile and facilitate the management of the process for making the pad, while they are distributed more homogeneously in the mixture when compared to larger-sized granules.

Alternatively, the matrix can be made from rubber and the granules are made from molybdenum disulphide. In this case, preferably, the granules have an average size of less than 20 μm, so as to amalgamate in the best way with the rubber matrix.

Alternatively, the granules can be made from a metallic material, which is preferably zinc, iron, steel, aluminium, copper or silver. In this case, the granules have an average size of less than 1 μm, to avoid abrasion to the rim.

Preferably, the pad is made from a mixture comprising, by weight, 30-60% rubber and 4-50% granules. A larger amount of granules can jeopardize the braking performance, whereas a smaller amount is insufficient to ensure the desired heat dispersal.

More preferably, the mixture comprises, by weight, 30-40% rubber, 40-60% cork and 4-20% granules and, even more preferably, the sum of the percentage weight of cork and of granules is less than or equal to 65%. The presence of cork in the mixture has been found particularly advantageous to decrease the wear both of the rim, in particular of a fiber rim, and of the pad itself, without decreasing the braking power. This mixture has also proven particularly suitable for decreasing noise during braking and for promoting good braking performance in both wet and dry conditions. With the indicated amounts, no difficulties of aggregation with the rubber were encountered.

Preferably, the cork is in the form of granules having an average size of 0.3-1 mm, and more preferably 0.5-0.7 mm. In this case, granules of material with high thermal conductivity and of a smaller size than the granules of cork are preferred, so as to be able to insert themselves in the gaps between the granules of cork and promote aggregation.

Preferably, the granules are made of expanded natural graphite, in an amount equal to 4-15% by weight.

In a second aspect, the present invention concerns a wheel-brake assembly for a bicycle, comprising:
a wheel, including a rim having two opposite sides; and
a brake, including two brake pads, intended to be actuated during braking by pressing respective braking surfaces of the pads against the sides of the rim;
wherein each pad comprises heat transmission means for taking heat away from the braking surface.

Preferably, the rim is made from a composite material, since it is with this type of rim that the advantages of the invention are most appreciable.

Preferably, each pad is mounted on a respective brake through a pad-carrying support. More preferably, each pad comprises a heat exchange surface towards the outside of the pad, in contact with the respective pad-carrying support, and the thermal transmission means transmit heat from the braking surface to the heat exchange surface and from here to the pad-carrying support.

Preferably, each pad-carrying support is provided with finning to promote heat dispersal.

In a third aspect, the present invention concerns a mixture for the preparation of a brake pad for a brake of a bicycle, comprising rubber, cross-linking agents, and granules of material having greater a thermal conductivity than rubber.

### DETAILED DESCRIPTION

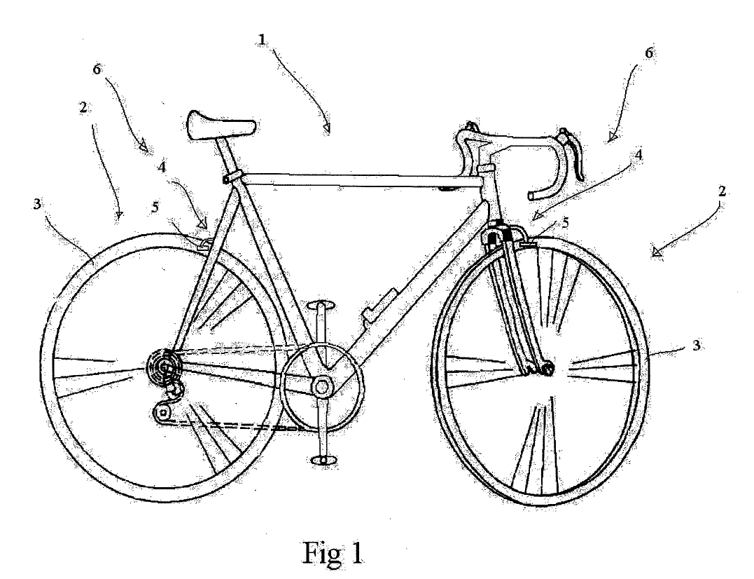

In FIG. 1, a bicycle 1 is represented, having a pair of wheels 2, each of which includes a rim 3. A brake 4 is provided for each wheel 2 and includes at least one brake pad, and more preferably a pair of brake pads 5, intended to act on the sides 8 of the rim 3 by friction as a result of a command imparted by a brake control system (per sé conventional and not illustrated), thus carrying out the braking of the wheel.

The rim 3 is made from composite material, such as the type comprising structural fibres incorporated in a polymeric material. Typically, the structural fibres are selected from the group consisting of carbon fibres, glass fibres, aramid fibres, ceramic fibres, boron fibres and combinations thereof. Carbon fibres are particularly preferred.

The arrangement of the structural fibres in the polymeric material can be a random arrangement of pieces or sheets of structural fibres, an ordered substantially unidirectional arrangement of fibres, an ordered substantially bidirectional arrangement of fibres, or a combination of the above.

Preferably, the polymeric material is thermosetting and preferably comprises an epoxy resin. However, this does not rule out the possibility of using a thermoplastic material.

The rim 3, in general, is made by overlapping a series of sheets of composite material that stick together due to the resin.

The rim 3 and the pad 5 are the essential elements of the wheel-brake assembly 6 of the bicycle 1.

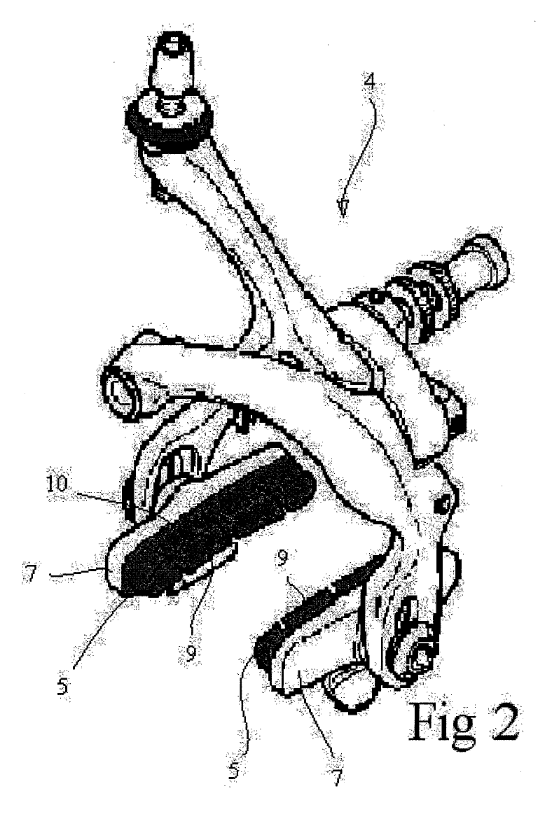

FIG. 2 shows the brake 4 in greater detail, which includes a pad-carrying support 7, by means of which each pad 5 is mounted in the brake 4.

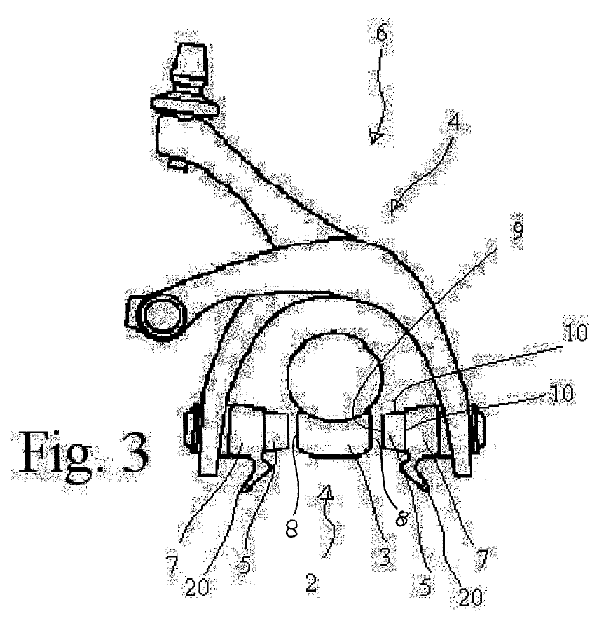

FIG. 3 schematically illustrates the mutual assembly position of the brake 4 and of the wheel 2 on the bicycle 1 in the rest condition, i.e. when the pad 5 is not acting upon the sides 8 of the rim 3.

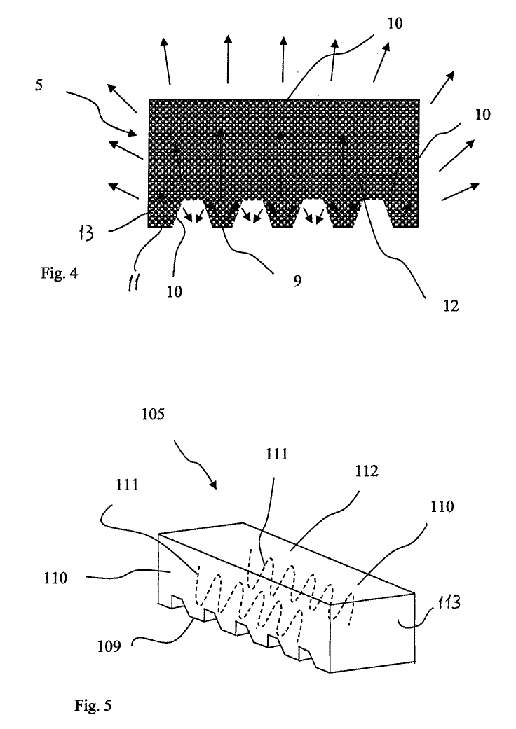

FIG. 4 shows the brake pad 5, made in accordance with the present invention, in greater detail. The pad 5 comprises a braking surface 9, intended to come into contact with the side 8 of the rim 3 during braking, and a plurality of other surfaces 10 intended to not come into contact with the side 8 of the rim 3. The braking surface 9 and the other surfaces 10 define the body 12 of the pad 5. In particular, the surfaces 10 comprise all of the outer surfaces of the pad 5, other than the braking surface 9, including indentation surfaces that project from the braking surface towards the inside of the pad 5 and the surfaces intended to possibly come into contact with the pad-carrying support 7.

The body 12 of the pad 5 comprises a matrix 13 of high-friction material in which thermal transmission means that are suitable for transferring heat from the braking surface 9 to the other surfaces 10 are incorporated.

More specifically, the body 12 is made of a mixture comprising rubber, cross-linking agents, and a powder of material having a higher heat conduction coefficient than rubber, which forms the thermal transmission means.

The powder consists of granules 11, preferably distributed homogeneously throughout the body 12 of the pad 5, and preferably, but not necessarily, in an amount that permits contact between at least some adjacent granules 11 so as to constitute random heat transmission channels from the braking surface 9 inside the pad 5, towards the other surfaces 10. It should be noted that FIG. 4 is only schematic and is not necessarily indicative of the distribution of the granules 11.

The surfaces 10 are heat exchange surfaces on the outside of the pad 5. The heat exchange surfaces 10 can be in contact with the pad-carrying support 7, or they can be in direct contact with the air. Advantageously, the random distribution of the granules 11 ensures that each surface of the pad 5, other than the braking surface 9, is a heat exchange surface 10, either with air or with another body, such as the pad-carrying support, and therefore a cooling surface. The efficiency of the heat exchange compared to a conventional brake pad is enormously increased. The total heat exchange surface of the pad 5 is the sum of all of the surfaces 10, and is therefore much greater than the braking surface 9 where the heat is generated.

The pad-carrier 7 can be equipped with cooling fins 20 (FIG. 3) to further increase the heat exchange surface.

In FIG. 4, the arrows schematically indicate the heat transmission flow inside and outside of the pad 5. In order to maximize heat flow, it is advantageous to use granules 11 of a material having a heat transmission coefficient of over 50 W/m° K, and even more preferably over 150 W/m° K.

As term of comparison, the matrix used for the present pad preferably has a heat transmission coefficient of less than 0.5 W/m° K, and therefore should be considered an insulating material.

Preferably, the granules 11 have an average size of less than 500 μm, and even more preferably less than 200 μm. In the preferred case in which granules 11 made from graphite are used, and in particular from expanded natural graphite which is also particularly suitable due to its low specific weight that does not increase the weight of the pad 5, the size of the granules 11 is preferably between 10 μm and 100 μm.

According to a possible variant, the granules 11 can be made from molybdenum disulphide, and have an average size of less than 20 μm.

According to a further variant, the granules 11 can be made from metallic material, such as zinc, iron or steel, but more preferably aluminium, and even more preferably silver or copper. These materials have particularly high heat transmission coefficients. In these variants, the size of the granules 11 is under 1 μm.

In general, the mixture from which the brake pad 5 is made must comply with the following formulation, given in percentage weight of the components: 30%-60% rubber and 4%-50% granules 11.

A first preferred mixture that complies with the general formulation is given by: 30%-40% rubber, 40%-60% cork and 4%-20% granules 11. In this case, it should be noted that the allowable percentage of granules 11 is reduced, to avoid problems of aggregation due to the simultaneous presence of cork. In particular, the cork can be introduced in the form of granules having an average size of between 0.3 and 1 mm, more preferably between 0.5 and 0.7 mm; the granules 11 of material with high thermal conductivity preferably have a smaller size than cork, because they can insert themselves into the gaps between the granules of cork.

A second preferred mixture that complies with the general formulation comprises 30%-40% rubber, 40%-60% cork and 4%-15% granules 11 of expanded natural graphite. Since both graphite and cork are elements that are foreign to rubber, they worsen its aggregation. Among all of the mentioned types of granules 11, expanded natural graphite is the one that worsens the aggregation the least. In order to limit this effect, it is preferable that the percentages of graphite remain in the lower part of the range, for example from 4% to 10%, when there are high percentages of cork, for example from 45% to 55%.

In any case, preferably, the sum of the amount of cork and of granules 11 is 65% or less by percentage weight.

All of the mixtures also contain a cross-linking agents for the rubber. The cross linking agent is preferably made up of a polymer selected from acrylonitrile butadiene, hydrogenated acrylonitrile butadiene, styrene butadiene, ethylene-propylene, chloroprene, or combinations thereof.

FIG. 5 illustrates a pad 105 according to an alternative embodiment of the invention, in which the heat is transferred from the braking surface 109 inside the pad 105, towards the heat exchange surfaces 110 through thermoconductor filaments 111, incorporated in the matrix 113 of the body 112 of the pad 105. Copper filaments are particularly preferred, arranged immediately below the braking surface 109, for example, at a distance of about 3 mm from it; with this distance, they maintain a good ability to collect heat from the braking surface 109 while still avoiding them being able to reach the braking surface 109 and abrade the side 8 of the rim 3 during braking, as the pad 105 wears down.

The pads indicated above can of course also be used in conjunction with rims made from metallic material, such as aluminium alloys, even if the cooling effect is less evident.

What is claimed is:

1. A brake pad (5, 105) for a brake (4) of a bicycle (1) comprising a braking surface (9, 109) intended to be pressed during braking against a side (8) of a rim (3) of a wheel (2) of the bicycle (1), wherein the brake pad comprises thermal transmission means (11, 111) suitable for transferring heat away from the braking surface (9, 109).

2. The pad of claim 1 comprising a heat exchange surface (10, 110) located towards the outside of the pad (5, 105), and distinct from the braking surface (9, 109), wherein the thermal transmission means (11, 111) transmit heat from the braking surface (9, 109) to the heat exchange surface (10, 110).

3. The pad of claim 2 wherein the heat exchange surface (10, 110) is suitable for coming into contact with a pad-carrying support (7) or with air.

4. The pad of claim 1 comprising a matrix (13, 113) of high-friction material, wherein the thermal transmission means comprise filaments (111) of material having higher thermal conductivity than the material of the matrix (13, 113), incorporated in the matrix (13, 113).

5. The pad of claim 4 wherein said filaments (111) are close to the braking surface (109) but are not present on it.

6. The pad of claim 4 wherein said filaments (111) are made from a material having thermal conductivity of over 50 W/m° K, preferably over 150 W/m° K.

7. The pad of claim 6 wherein said filaments (111) are made from metallic material.

8. The pad of claim 1 comprising a matrix (13, 113) of high-friction material, wherein the thermal transmission means comprise granules (11) of material having higher thermal conductivity than the material of the matrix (13, 113), incorporated in the matrix (13, 113).

9. The pad of claim 8 wherein said granules (11) are distributed throughout the matrix (13, 113), including the braking surface (9).

10. The pad of claim 8 wherein said granules (11) are made from a material having thermal conductivity of over 50 W/m° K.

11. The pad of claim 10 wherein said granules (11) are made from a material having thermal conductivity of over 150 W/m° K.

12. The pad of claim 8 wherein said granules (11) have an average size of less than 500 μm.

13. The pad of claim 12 wherein said granules (11) have an average size of less than 200 μm.

14. The pad of claim 8 wherein the matrix (13, 113) is made from rubber and the granules (11) are made from graphite, preferably expanded natural graphite.

15. The pad of claim 14 wherein the granules (11) have an average size of between 10 μm and 100 μm.

16. The pad of claim 8 wherein the matrix (13, 113) is made from rubber and the granules (11) are made from molybdenum disulphide.

17. The pad of claim 16 wherein the granules (11) have an average size of less than 20 μm.

18. The pad of claim 8 wherein the granules (11) are made from metallic material.

19. The pad of claim 18 wherein the granules (11) have an average size of less than 1 μm.

20. The pad of claim 8 made from a mixture comprising, by weight, 30-60% rubber and 4-50% granules (11).

21. The pad of claim 20 wherein the mixture comprises, by weight, 30-40% rubber, 40-60% cork and 4-20% granules (11).

22. The pad of claim 21 wherein the sum of the percentage weight of cork and of granules (11) is less than or equal to 65%.

23. The pad of claim 21 wherein the cork is comprised in granules of an average size of 0.3-1 mm.

24. The pad of claim 21 wherein said granules (11) are made from expanded natural graphite, in an amount equal to 4-15% by weight.

25. The pad of claim 7 wherein the metallic material is selected from the group consisting of zinc, iron, steel, aluminium, copper and silver.

26. The pad of claim 18 wherein the metallic material is selected from the group consisting of zinc, iron, steel, aluminium, copper and silver.

27. The pad of claim 23 wherein the cork granules have an average size of 0.5-0.7 mm.

28. A wheel-brake assembly (6) for a bicycle (1) comprising:
a wheel (2), including a rim (3) having two opposite sides (8); and
a brake (4), including two brake pads (5, 105), intended to be actuated during braking in the sense of pressing respective braking surfaces (9,109) of the pads (5, 105) against the sides (8) of the rim (3);
wherein each pad (5, 105) comprises heat transmission means (11, 111) taking heat away from the braking surface (9, 109).

29. The assembly of claim 28 wherein the rim (3) is made from composite material.

30. The assembly of claim 28 wherein each pad (5,105) is mounted on the respective brake (4) through a pad-carrying support (7).

31. The assembly of claim 30 wherein each pad (5, 105) comprises a heat exchange surface (10, 110) located towards the outside of the pad (5, 105), in contact with the respective pad-carrying support (7), wherein the thermal transmission means (11, 111) transmit heat from the braking surface (9, 109) to the heat exchange surface (10, 110) and from here to the pad-carrying support (7).

32. The assembly of claim 31 wherein each pad-carrying support (7) is provided with finning (20) to promote heat dispersal.

33. A mixture for the preparation of a brake pad (5, 105) for a brake (4) of a bicycle (1), comprising rubber, cross-linking agents and granules (11) of material having greater thermal conductivity than rubber.

34. The mixture of claim 33 wherein said granules (11) are made of material having thermal conductivity of over 50 W/m° K.

35. The mixture of claim 34 wherein said granules (11) have an average size of less than 500 μm.

36. The mixture of claim 35 wherein the granules (11) are made of graphite.

37. The mixture according to claim 35 wherein the granules (11) are made of molybdenum disulphide and have an average size of less than 20 μm.

38. The mixture of claim 35 wherein the granules (11) are made of metallic material and have an average size of less than 1 μm.

39. The mixture of claim 33 comprising, by weight, 30-60% rubber and 4-50% granules (11).

40. The mixture of claim 39 comprising, by weight, 30-40% rubber, 40-60% cork and 4-20% granules (11).

41. The mixture of claim 40 wherein the sum of the percentage weight of cork and of granules (11) is less than or equal to 65%.

42. The mixture of claim 40 wherein the cork is comprised in granules of an average size of 0.3-1 mm, preferably 0.5-0.7 mm.

43. The mixture of claim 40 wherein said granules (11) are made of expanded natural graphite, in an amount equal to 4-15% by weight.

44. The mixture of claim 36 wherein the granules are made of expanded natural graphite and have an average size between 10 μm and 100 μm.

45. The mixture of claim 38 wherein the metallic material is selected from the group consisting of, iron, steel, aluminium, copper or silver.

46. The mixture of claim 35 wherein the granules have an average size of less than 1 μm.

47. A bicycle brake pad (5, 105) comprising: a braking surface (9, 109) configured to press against a side (8) of a rim (3) of a wheel (2) of the bicycle (1) during braking, and a thermal transmitter (11, 111) that transfers heat from the braking surface (9, 109).

48. The pad (5, 105) of claim 47 further comprising at least one heat exchange surface (10, 110) that does not contact the rim (3) during braking and to which the thermal transmitter (11, 111) transfers heat during braking.

49. The pad (5, 105) of claim 48 wherein the thermal transmitter comprises granules (11) of thermally transmitting material distributed homogenously throughout the brake pad (5, 105).

50. The pad (5, 105) of claim 49 wherein at least some of the granules (11) contact other granules (11) to form heat transmission channels.

51. The pad (5, 105) of claim 50 comprising cork.

52. A bicycle wheel and brake assembly (6) comprising:
a wheel (2) that includes a rim (3) with two opposite sides (8); and
a brake assembly (4) positioned over the rim (3) that includes brake pad holders (7) that position a respective one of two brake pads (5, 105) adjacent the opposite sides (8) of the rim (3), and each of the pads (5, 105) incorporates a thermal transmitter (11, 111) that transfers heat from the braking surface (9, 109).

53. The assembly (6) of claim 52 wherein the rim (3) is made from a composite material.

54. The assembly (6) of claim 53 wherein the composite material comprises structural fibers selected from the group consisting of carbon fibers, glass fibers, aramid fibers, ceramic fibers, boron fibers, and combinations thereof.

55. The assembly (6) of claim 54 wherein the composite material comprises a matrix of thermosetting polymeric material.

56. The assembly (6) of claim 55 wherein the thermosetting polymeric material is epoxy.

57. A bicycle brake pad (5, 105) comprising: rubber; a cross-linking agent selected from the group of acrylonitrile butadiene, hydrogenated acrylonitrile butadiene, styrene butadiene, ethylene propylene, chloroprene and combinations thereof; and thermal transmission granules (11) having a thermal conductivity greater than the rubber.

58. The pad (5, 105) of claim 57 further configured to have at least one heat exchange surface (10, 110) that does not contact the rim (3) during braking and to which the thermal granules (11) transfer heat to during braking.

59. The pad (5, 105) of claim 57 wherein the rubber is a matrix in which the thermal transmission granules (11) are embedded.

60. The pad (5, 105) of claim 57 wherein the thermal transmission granules (11) are distributed homogenously throughout the brake pad (5, 105).

61. The pad (5, 105) of claim 57 wherein the thermal transmission granules (11) form heat transmission channels.

62. The pad (5, 105) of claim 58 wherein at least some of the heat exchange surfaces (10, 110) are in contact with air.

63. The pad (5, 105) of claim 58 wherein at least some of the heat exchange surfaces (10, 110) contact a support (7) that carries the pad (5, 105).

64. The pad (5, 105) of claim 57 wherein the thermal transmission granules (11) comprise a material having a heat transmission coefficient over 150 W/m° K.

65. The pad (5, 105) of claim 57 wherein the rubber has a heat transmission coefficient of less than 0.5 W/m° K.

66. The pad (5, 105) of claim 57 comprising, by weight, 30%-40% rubber, 40%-60% cork, and 4%-20% thermal transmission granules (11).

67. A bicycle brake pad (5, 105) comprising: rubber; a cross-linking agent selected from the group of acrylonitrile butadiene, hydrogenated acrylonitrile butadiene, styrene butadiene, ethylene propylene, chloroprene and combinations thereof; and thermal transmission granules (11) having a thermal conductivity greater than the rubber, wherein the thermal transmission granules (11) form heat transmission channels.

68. A bicycle brake pad (105) having thermoconductor filaments (111) that transfer heat away from the braking surface (109) during braking.
